(19) United States
(12) Patent Application Publication
(10) Pub. No.: US 2026/0058932 A1
(43) Pub. Date: Feb. 26, 2026

(54) ROUTING TABLE SELECTION BASED ON ALTERNATE ROUTE INDICATOR

(71) Applicant: HEWLETT PACKARD ENTERPRISE DEVELOPMENT LP, Spring, TX (US)

(72) Inventors: Srinivasan Jayarajan, Bangalore (IN); Zhijun Ren, Beijing (CN)

(21) Appl. No.: 18/928,470

(22) Filed: Oct. 28, 2024

(30) Foreign Application Priority Data
Aug. 23, 2024 (IN) 202441063713

(51) Int. Cl. H04L 9/40; H04L 45/745

(52) U.S. Cl. CPC H04L 63/0236; H04L 45/745; H04L 63/0263

(57) ABSTRACT

In some examples, a computing device includes a virtual compute entity and a virtual network interface between the virtual compute entity and a network outside the computing device. The computing device stores a first routing table used for routing of packets directed to the virtual network interface, and a second routing table used for routing of packets directed to another interface different from the virtual network interface in the computing device. Based on a packet satisfying a packet filter rule, the computing device associates the packet with an alternate route indicator for an IP flow, the alternate route indicator specifying use of the first routing table instead of the second routing table to address an IP subnet collision between an IP subnet of the virtual network interface and an IP subnet of another entity.

### BACKGROUND

Virtualization can be performed in a computing device to create virtual compute entities in the computing device. Examples of virtual compute entities include containers and virtual machines (VMs). A program running in a virtual compute entity of the computing device can communicate with internal entities of the computing device or with external entities outside the computing device.

### BRIEF DESCRIPTION OF THE DRAWINGS

Some implementations of the present disclosure are described with respect to the following figures.

FIG. 1 is a block diagram of an arrangement that includes a computing device coupled to a remote server and a remote client over an external network, in accordance with some examples.

FIG. 2 is a flow diagram of a layer 3 packet filter process according to some examples.

FIG. 3 is a flow diagram of an internal Address Resolution Protocol (ARP) handling process according to some examples.

FIG. 4 is a block diagram of a computing device according to some examples.

FIG. 5 is a block diagram of a storage medium storing machine-readable instructions according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In a computing device (also referred to as a “host device”) with a virtual environment including one or more virtual compute entities, a virtual network interface (also referred to as a virtual gateway bridge) can be set up to allow communications between programs of the virtual compute entities in the host device and external entities outside the host device. The virtual gateway bridge acts as a transit point for traffic between the programs of the virtual compute entities in the host device and the external entities. The virtual gateway bridge is part of an Internet Protocol (IP) subnet, which can be referred to as a “virtual interface IP subnet.” The virtual interface IP subnet has a range of IP addresses. The virtual gateway bridge can be assigned an IP address from this range of IP addresses. An IP address of the virtual interface IP subnet has two parts: a routing prefix (also referred to as a network number) that identifies the virtual interface IP subnet, and a host identifier that identifies an entity on the virtual interface IP subnet, such as the virtual gateway bridge. Virtual compute entities attached to the virtual gateway bridge are also assigned IP addresses from this virtual interface IP subnet.

A collision of IP subnets can occur if either: (1) the virtual interface IP subnet of the virtual gateway bridge is the same as an IP subnet assigned to an external entity outside the host device, or (2) the virtual interface IP subnet is the same as an IP subnet assigned to a physical or virtual interface in the same host device. As an example of scenario (1), an IP address 172.18.0.2/24 assigned to the virtual gateway bridge indicates that the virtual interface IP subnet of the virtual gateway bridge is represented by 172.18.0 (the routing prefix). The value “24” following the “/” in the IP address refers to the number of bits of an IP mask that are all set to “1” to indicate the length of the routing prefix of an IP address. If an external entity is assigned an IP address 172.18.0.x/24 (where x is the host identifier of the external entity), then the external entity is part of an IP subnet that would collide with the virtual interface IP subnet of the virtual gateway bridge. Similarly, scenario (2) may arise if the same IP subnet is assigned to the virtual gateway bridge and another physical or virtual internal interface in the same host device.

If a collision of IP subnets is present (e.g., the virtual interface IP subnet and the IP subnet of an external entity are both represented by 172.18.0.x/24, which indicates that 172.18.0 is the routing prefix and “x” can be any value), then a network stack of an operating system (OS) kernel in the host device would not be able to properly route an outbound packet from an internal entity to an intended target. For example, the internal entity in the host device may send the outbound packet with the destination IP address of 172.18.0.x, which is the IP address of the external entity. However, due to the presence of the collision of IP subnets, the network stack of the OS kernel may mistakenly determine, based on a routing table in the host device, that the packet is to be routed to the virtual interface IP subnet instead of to the IP subnet of the external entity. As a result, the packet may not reach the intended target.

A misrouting based on the routing table may also occur for an incoming packet from the external entity received by the host device due to presence of the IP subnet collision.

In addition to an IP subnet collision causing misrouting of layer 3 (L3) packets such as IP packets, the IP subnet collision may also cause mishandling of layer 2 (L2) packets. An L3 packet (an IP packet) includes a source IP address to identify a source of the L3 packet, and a destination IP address to identify a destination of the L3 packet. An L2 packet includes a source Media Access Control (MAC) address to identify the source and a destination MAC address to identify the destination. An example of an L2 packet is an Address Resolution Protocol (ARP) packet used for determining an L2 address (e.g., a MAC address) given an L3 address (e.g., an IP address) (or vice versa). The presence of the IP subnet collision may cause the OS kernel to drop the ARP packet. Further, if the virtual gateway bridge in the host device is assigned the same IP subnet as an external server, both the host device and the external server may respond to an ARP request, which can confuse an external client that sent the ARP request.

In accordance with some implementations of the present disclosure, an alternate routing table (that is in addition to one or more primary routing tables) is created for an IP subnet of a virtual gateway bridge in a host device, where the alternate routing table can be used for determining routes for the IP traffic that pass through the virtual gateway bridge between an internal entity inside the host device and an external entity outside the host device. The use of the alternate routing table is specified based on an alternate route indicator associated with an IP flow including packets. The alternate route indicator can be stored in packet metadata that an operating system (OS) kernel uses to determine that the alternate routing table is to be used instead of one or more main or local routing tables in the host device. The use of the alternate routing table isolates the IP subnet of the virtual gateway bridge from other IP subnets in the host device.

A “primary routing table” can refer to a main routing table or a local routing table in the host device that the OS kernel (and more specifically, the network stack of the OS kernel) normally uses for routing a data packet. For example, the main routing table may be used to route a packet to an external entity outside the host device. A local routing table may be used to route a packet to an internal entity of the host device.

In accordance with some implementations of the present disclosure, the alternate route indicator is set for packets that satisfy one or more specified packet filter rules. The packets that satisfy such specified packet filter rules and for which the alternate route indicator is set would use the alternate routing table instead of the primary routing table (the main routing table or the local routing table). The alternate route indicator can be set for both outbound packets and inbound packets that traverse the virtual gateway bridge, to trigger the use of the alternate routing table. The one or more specified packet filter rules may indicate that the alternate route indicator is set for a packet of an IP flow being destined to the virtual gateway bridge and targeted to a specified destination port number. The alternate routing table can be used for both IP version 4 (IPv4) and IP version 6 (IPv6) flows.

Additionally, the alternate route indicator can be set for certain L2 packets, such as ARP request packets, that seek information (e.g., a MAC address) of the virtual gateway bridge or otherwise affect an ability to interact with the virtual gateway bridge. For such L2 packets, the alternate routing table can be used to check that the L2 packets relate to the virtual gateway bridge. Further, the alternate route indicator can be set where an internal entity within the host device seeks to access a virtual compute entity in the host device, to trigger the use of the alternate routing table to ensure that a packet targeted to the virtual compute entity in the host device is not routed to an external entity.

Additionally, in some examples, to avoid the issue of both the virtual gateway bridge in the host device and an external server responding to an ARP request from an external client that sent the ARP request, a configuration of the OS kernel (such as a configuration in a network stack of the OS kernel) may be set to prevent a host device from responding to an ARP request from an external client.

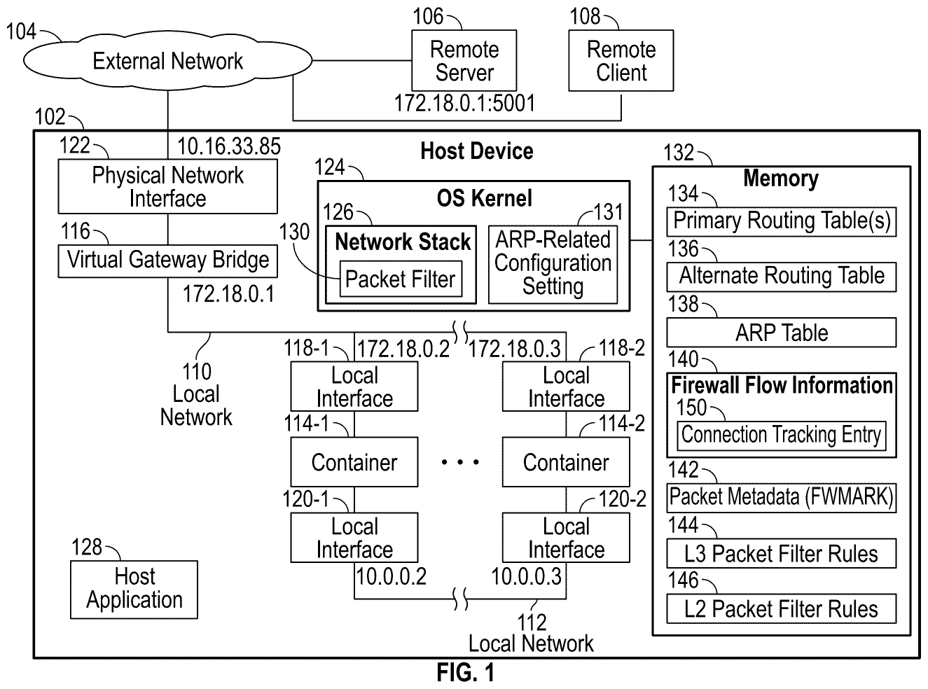

FIG. 1 is a block diagram of an example arrangement that includes a host device 102 that is connected to an external network 104 to other devices, including a remote server 106 and a remote client 108. An external network refers to a network that is outside the host device 102. The host device 102 also includes one or more local networks, including a local network 110 and a local network 112 in the example shown. Although two local networks are depicted in FIG. 1, in other examples, a different quantity of local networks (one or more) can be included in the host device 102. A local network is a network inside the host device 102 over which entities of the host device 102 can communicate with one another.

In accordance with some examples of the present disclosure, the host device 102 includes various virtual compute entities, including containers 114-1 and 114-2. Although just two containers are shown, in other examples, a different number (one or more) of containers may be included in the host device 102. Instead of or in addition to containers, the host device 102 can execute other virtual compute entities, such as virtual machines (VMs).

In some examples, the host device 102 can be a network device, such as an access point (AP) or a gateway device connected to a wireless local area network (WLAN). In other examples, the host device 102 can be a different type of network device, such as a switch or router. In further examples, the host device 102 can include other types of electronic devices, including desktop computers, notebook computers, tablet computers, server computers, storage systems, vehicles, household appliances, and so forth.

The host device 102 includes a virtual gateway bridge 116 (implemented with machine-readable instructions) that is connected to the local network 110. The virtual gateway bridge 116 is part of a virtual interface IP subnet. In the example of FIG. 1, the virtual gateway bridge 116 is assigned an IP address 172.18.0.1, of which 172.18.0 constitutes the routing prefix defining the virtual interface IP subnet. The containers 114-1 and 114-2 are coupled to the local network 110 through respective local interfaces 118-1 and 118-2. The local interface 118-1 is assigned an IP address 172.18.0.2, and the local interface 118-2 is assigned an IP address 172.18.0.3. The local interfaces 118-1 and 118-2 are also part of the virtual interface IP subnet (identified by 172.18.0 in the example). Although specific IP addresses are given in the example of FIG. 1, it is noted that in other examples different IP addresses can be assigned to respective entities.

The containers 114-1 and 114-2 are also coupled through respective local interfaces 120-1 and 120-2 to the local network 112. The local interface 120-1 is assigned an IP address 10.0.0.2, and the local interface 120-2 is assigned an IP address 10.0.0.3. The local interfaces 120-1 and 120-2 are part of another IP subnet defined by the routing prefix of the IP addresses 10.0.0.2 and 10.0.0.3. In other examples, the containers 114-1 and 114-2 are not connected to the local network 112.

Local interfaces 118-1, 118-2, 120-1, and 120-2 are virtual interfaces that allow the containers 114-1 and 114-2 to communicate with local networks.

The host device 102 also includes a physical network interface 122, which is a physical component that allows the host device 102 to connect to the external network 104. For example, the physical network interface 122 can include a network interface controller as a single transceiver to transmit and receive signals. In the example of FIG. 1, the physical network interface is assigned an IP address 10.16.33.85, which is the IP address used for communications between the host device 102 and an external entity, such as the remote server 106 and the remote client 108.

Packets sent from the host device 102, such as to the remote server 106, would include this IP address 10.16.33.85 as the source IP address. Similarly, packets sent to the host device 102, such as from the remote client 108, would include this IP address 10.16.33.85 as the destination IP address.

When a packet is communicated through the virtual gateway bridge 116 between an entity inside the host device 102 and an external entity, the virtual gateway bridge 116 can perform network address translation to translate between the external IP address 10.16.33.85 of the host device 102 and an internal IP address used in the host device 102.

The host device 102 also includes an OS kernel 124, which is the core of an OS to perform specific functionalities of the OS. The OS kernel 124 includes a network stack 126 (implemented with machine-readable instructions, for example) that has various protocol layers for communications of data. For example, the network stack 126 can include a link layer (layer 2), a network layer (layer 3), and a protocol layer (layer 4). The link layer can be an Ethernet layer, the network layer can be an IP layer, and the protocol layer can be a Transmission Control Protocol (TCP) layer or a User Datagram Protocol (UDP) layer. Packets that pass through the network stack 126 are communicated with an entity in an application layer, where the entity in the application layer may be in one of the containers 114-1 and 114-2, or another virtual compute entity, or a host application 128 executed in the host device 102.

An outbound packet from the host device 102 can be sent from a container (114-1 or 114-2) or the host application 128 to an external entity, such as the remote server 106. An inbound packet is sent to the host device 102, such as from the remote client 108, for receipt by a container or the host application 128. Outbound and inbound packets pass through the virtual gateway bridge 116 (as well as through the physical network interface 122).

The host device 102 also includes a memory 132 that stores various data structures, including primary routing table(s) 134 (main and local routing tables), an alternate routing table 136 that is used instead of the primary routing table(s) 134 based on an alternate route indicator being set for a packet of an IP flow. In some examples, entries containing routes and interface information for the virtual gateway bridge 116 are moved from the main routing table to the alternate routing table 136.

Other data structures in the memory 132 include an ARP table 138 that is used to correlate IP addresses and MAC addresses, firewall flow information 140, packet metadata 142, layer 3 (L3) packet filter rules 144, and layer 2 (L2) packet filter rules 146.

Although the various data structures in FIG. 1 are shown as being stored in one memory 132, in other examples, some of the data structures may be stored in one or more other memories. A memory can include a persistent memory, which is able to maintain stored data even if power were removed from the persistent memory. A memory can alternatively include a volatile memory, which loses its stored data if power were removed from the volatile memory. All of the data structures shown in FIG. 1 may be stored in persistent memory, or alternatively, some of the data structures may be stored in volatile memory.

The L3 packet filter rules 144 include rules that are used by a packet filter 130 in the network stack 126 to determine how to handle an L3 packet, including how to route the L3 packet. Similarly, the L2 packet filter rules 146 include rules that are used by the packet filter 130 to determine how to handle an L2 packet, including how to route the L2 packet. Although just one packet filter 130 is shown in FIG. 1, note that there may be multiple packet filters in the network stack 126, including packet filters at different layers of the network stack 126. The packet filter 130 can refer to a packet filter at any of the different layers of the network stack 126.

In an example, the L3 packet filter rules 144 include iptables rules (also referred to as iptables mangle rules). Iptables refers to a program used to set up IP packet filter rules of a firewall in the OS kernel 124 for handling L3 packets, such as IP packets. Instead of using iptables rules, nftables can be employed to define rules for handling L3 packets. In other examples, an extended Berkeley Packet Filter (eBPF) can be used to define rules for handling L3 packets.

In an example, the L2 packet filter rules 146 include ebtables rules. Ebtables refers to a program used to set up rules for handling L2 packets, such as Ethernet frames. Instead of using the ebtables rules, nftables can be employed to define rules for handling L2 packets.

The L3 packet filter rules 144 and the L2 packet filter rules 146 can be used by the packet filter 130 to set an alternate route indicator for a packet. In the example of FIG. 1, the alternate route indicator is represented as FWMARK (firewall mark), which is part of the packet metadata 142 stored in the memory 132. The packet metadata 142 is associated with an IP flow. An IP flow is defined by the following 5-tuple: a source IP address, a source port number, a destination IP address, a destination port number, and the transport protocol used, such as TCP or UDP. Note that multiple instances of the packet metadata 142 are maintained for respective different IP flows.

The alternate route indicator, FWMARK, can be set to an active value (e.g., “1” or “0”) to indicate that the alternate routing table 136 is to be used, or cleared to an inactive value (e.g., “0” or “1”) to indicate that a primary routing table is to be used. If the alternate route indicator, FWMARK, is set for a first IP flow, then the packet filter 130 would use the alternate routing table 136 to route any packet of the first IP flow, instead of a primary routing table, such as the primary routing table(s) 134. On the other hand, if the alternate route indicator, FWMARK, is cleared for a second IP flow, then the packet filter 130 would use a primary routing table to route any packet of the second IP flow.

It is noted that since the alternate route indicator, FWMARK, is set in the packet metadata 142, a packet in the IP flow does not have to be modified to include the alternate route indicator. Rather, for packets of the IP flow, the packet filter 130 can check the packet metadata 142 to determine whether the alternate route indicator, FWMARK, is set and if so, the network stack 126 uses the alternate routing table 136 to perform routing of packets of the IP flow.

In some examples, the alternate route indicator, FWMARK, for an IP flow can also be added to a connection tracking entry 150 for the IP flow. The connection tracking entry 150 is part of the firewall flow information 140. Connection tracking entries are used by the firewall of the OS kernel 124 to track how many connections (IP flows) are set up. For example, the connection tracking entry 150 can include the following information in addition to FWMARK: source IP address, destination IP address, and destination port number. The 5-tuple (a source IP address, a source port number, a destination IP address, a destination port number, and the transport protocol) of the IP flow can be matched to the information in the connection tracking entries of the firewall flow information 140 to determine which connection tracking entry is for the IP flow.

In some examples, the OS kernel 124 can restore the value of the alternate route indicator, FWMARK, from a connection tracking entry to corresponding packet metadata for each IP flow. This restoration may occur during startup of the host device 102, so that the state of the alternate route indicator, FWMARK, in packet metadata is made consistent with the respective connection tracking entry.

The L3 packet filter rules 144 may include a first packet filter rule for outbound L3 packets from a virtual compute entity that are to be passed through the virtual gateway bridge 116 to an external network (e.g., 104). This first packet filter rule may specify that for any outbound L3 packet sent to the virtual gateway bridge 116 and containing a specified destination port number (e.g., port number 5001 or any other defined port number) (or any other specified information such as an IPv4 or IPv6 protocol used or other information), the alternate route indicator, FWMARK, is set. The alternate routing table 136 includes an entry for an outbound L3 packet containing a destination IP address referring to the virtual gateway bridge 116. This entry would direct the outbound L3 packet to the virtual gateway bridge 116. A primary routing table would not have an entry for the outbound L3 packet containing a destination IP address referring to the virtual gateway bridge 116, so that a lookup of the primary routing table would result in no matching entry being found, which would result in the outbound L3 packet being dropped.

The L3 packet filter rules 144 may include a second packet filter rule for L3 packets that are sent from a source internal entity to a destination internal entity. An internal entity can refer to the container 114-1 or 114-2, the host application 128, or any other internal entity inside the host device 102. This second packet filter rule may specify that for any L3 packet sent to a local destination and containing a specified destination port number (e.g., port number 5001 or any other defined port number) (or any other specified information), the alternate route indicator, FWMARK, is set. As an example, the host application 128 may send an L3 packet destined to 10.16.33.85:5001, where the IP address 10.16.33.85 is that of a target container (114-1 or 114-2), and the port number is 5001. Note that the IP address 10.16.33.85 is also that of the physical network interface 122 (in other words, the physical network interface 122 and the container both share the same IP address). Because the destination IP address 10.16.33.85 in the L3 packet is the IP address of the physical network interface 122, the packet filter 130 would perform a network address translation of the destination IP address 10.16.33.85 to the IP address of the virtual gateway bridge 116. The translated destination IP address would be 172.18.0.1:5001 in this example. However, if the alternate route indicator, FWMARK, is not set, the packet filter 130 would perform a lookup of a primary routing table 134 (e.g., a local routing table), which would not have an entry for the 172.18.0 subnet (the virtual interface IP subnet). As a result, this lookup would fail and the packet filter 130 would not be able to route the L3 packet to the target container. However, if the alternate route indicator, FWMARK, is set, the packet filter 130 would perform a lookup of the alternate routing table 136, which would include an entry directing the L3 packet to the target container.

The L3 packet filter rules 144 may further include a third packet filter rule for inbound L3 packets received from an external entity and that are to be passed through the virtual gateway bridge 116 to a destination internal entity inside the host device 102. This third packet filter rule may specify that for any inbound L3 packet sent to a destination internal entity and containing a specified destination port number (e.g., port number 5001 or any other defined port number) (or any other specified information), the alternate route indicator, FWMARK, is set. An inbound L3 packet contains the IP address 10.16.33.85 of the physical network interface 122 as the destination IP address. The virtual gateway bridge 116 applies a network address translation to translate the destination IP address 10.16.33.85 to 172.18.0.1, which is the IP address of the virtual gateway bridge 116. The alternate routing table 136 includes an entry for an inbound L3 packet containing a destination IP address referring to the virtual gateway bridge 116 and that is targeted to a destination internal entity. This entry would direct the inbound L3 packet to the destination internal entity. A primary routing table would not have an entry for the inbound L3 packet containing a destination IP address referring to the virtual gateway bridge 116, so that a lookup of the primary routing table would result in no matching entry being found.

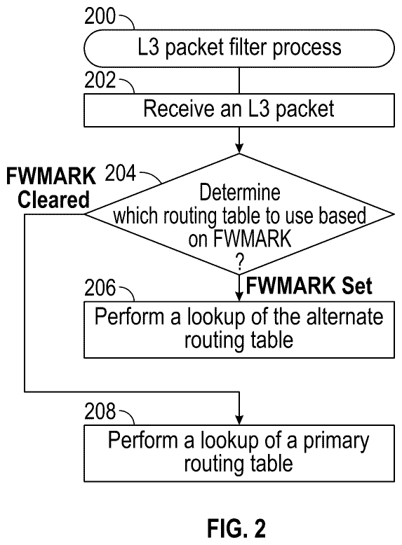

FIG. 2 is a flow diagram of an L3 packet filter process 200 performed by the packet filter 130, according to some examples of the present disclosure. Although FIG. 2 shows tasks of the L3 packet filter process 200 performed in a particular order, it is noted that in other examples, the tasks may be performed in a different order, some tasks may be omitted, and other tasks may be added.

The packet filter 130 receives (at 202) an L3 packet. The L3 packet may be an outbound L3 packet destined to an external entity outside the host device 102, an L3 packet sent from a source internal entity to a destination internal entity, or an inbound L3 packet destined to a destination internal entity. The packet filter 130 determines (at 204), using the L3 packet filter rules 144 (including the first, second, and third packet filter rules above), which routing table to use (a primary routing table 134 or the alternate routing table 136). Based on the L3 packet filter rules 144, the packet filter 130 determines whether the alternate route indicator, FWMARK, is to be set or cleared. Note that prior to checking the L3 packet filter rules 144, the packet filter 130 can check the connection tracking entry 150 for the IP flow that the L3 packet is part of, to determine whether FWMARK was previously set or cleared. If so, the packet filter 130 would use this previously programmed state of FWMARK.

If FWMARK is set, the packet filter 130 performs a lookup (at 206) of the alternate routing table 136 to determine how to route the L3 packet. Note that if the L3 packet is an outbound L3 packet destined to an external entity, a first entry of the alternate routing table 136 would direct the L3 packet to the virtual gateway bridge 116. If the L3 packet is an L3 packet sent from a source internal entity to a destination internal virtual compute entity, a second entry of the alternate routing table 136 would direct the L3 packet to the destination internal virtual compute entity. If the L3 packet is an inbound L3 packet destined to a destination internal virtual compute entity, a third entry of the alternate routing table 136 would direct the L3 packet to the destination internal virtual compute entity.

If FWMARK is cleared, the packet filter 130 performs a lookup (at 208) of a primary routing table to determine how to route the L3 packet. Once FWMARK has been set or cleared in the packet metadata 142 for a given IP flow, the packet filter 130 can consult the packet metadata 142 to determine, based on the state of FWMARK, which routing table to use for subsequent packets of the given IP flow.

For L2 packets, the L2 packet filter rules 146 are accessed to determine which of the primary routing table(s) 134 or alternate routing table 136 to use. As noted above, an example of an L2 packet is an ARP packet, including ARP requests and responses. Although some examples refer to ARP packets, it is noted that similar techniques can be used to handle other types of L2 packets.

Several issues are associated with the handling of ARP packets.
Issue 1: The absence of information for the virtual gateway bridge 116 in a primary routing table 134 may cause the OS kernel 124 to drop an ARP packet since a lookup attempt in the primary routing table would fail.
Issue 2: If the virtual gateway bridge 116 in the host device 102 is assigned the same IP subnet as an external server (e.g., 106), both the host device 102 and the external server may respond to an ARP request from a client (e.g., the remote client 108), which can confuse the client that sent the ARP request.

With Issue 1, an internal entity (e.g., the container 114-1 or 114-2) of the host device 102 may send an ARP request that is received by the OS kernel 124. The ARP request sent by the internal entity seeks a MAC address of the virtual gateway bridge 116. The internal entity is aware of the IP address of the virtual gateway bridge 116, but does not have the MAC address of the virtual gateway bridge 116. The ARP request sent by the internal entity is referred to as an internal ARP request. The internal entity obtains the MAC address of the virtual gateway bridge 116 to perform communications with an external entity.

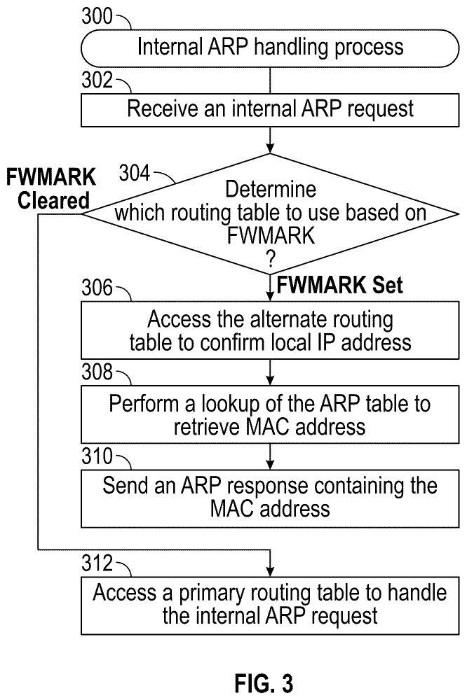

FIG. 3 shows an internal ARP handling process 300 of the OS kernel 124 in response to receiving (at 302) the internal ARP request. Although FIG. 3 shows tasks of the internal ARP handling process 300 performed in a particular order, it is noted that in other examples, the tasks may be performed in a different order, some tasks may be omitted, and other tasks may be added.

The internal ARP request includes a target IP address of the virtual gateway bridge 116. The OS kernel 124 performs a validation of the internal ARP request to ensure that the target IP address included in the internal ARP request is a local IP address belonging to an entity in the host device 102. This validation is based on accessing a routing table. Note that if the OS kernel 124 accesses a primary routing table 134 to perform this validation, the primary routing table 134 would not have an entry for the IP address of the virtual gateway bridge 116. As a result, the validation would fail and the OS kernel 124 would drop the internal ARP request.

In accordance with some examples of the present disclosure, for the internal ARP request, the OS kernel 124 determines (at 304), based on a given rule in the L2 packet filter rules 146, which routing table to use (a primary routing table 134 or the alternate routing table 136). The given rule of the L2 packet filter rules 146 (e.g., ebtables rules) can specify that ARP requests from an internal entity of the host device 102 and targeted to the IP address of the virtual gateway bridge 116 are to be marked by setting the alternate routing indicator, FWMARK.

Based on FWMARK being set, the OS kernel 124 accesses (at 306) the alternate routing table 136 to confirm that the IP address in the internal ARP request is a local IP address. Since the alternate routing table 136 has an entry for the IP address of the virtual gateway bridge 116, the OS kernel 124 is able to successfully perform this confirmation. As a result, the OS kernel 124 performs a lookup (at 308) of the ARP table 138 to retrieve the MAC address corresponding to the IP address of the virtual gateway bridge 116. The OS kernel 124 then sends (at 310) an ARP response containing the MAC address to the internal entity that sent the ARP request.

However, if the FWMARK is cleared, the OS kernel 124 accesses (at 312) a primary routing table 134 to handle the internal ARP request (which in this latter case specifies an IP address of an internal entity other than the virtual gateway bridge 116).

Issue 2 relates to an external ARP request (such as from the remote client 108) that is received at the host device 102. The external ARP request sent by the remote client 108 may be targeted to the remote server 106, which has an IP address of 172.18.0.1. However, this IP address is also the IP address of the virtual gateway bridge 116. In this scenario, both the remote server 106 and the OS kernel 124 in the host device 102 may send ARP responses in response to the external ARP request from the remote client 108. This can lead to an error at the remote client 108 since the ARP responses may contain conflicting information that the remote client 108 is unable to resolve.

To address the foregoing issue, the OS kernel 124 can set an ARP-related configuration setting 131 associated with the network stack 126 to specify that an incoming interface would reply to an ARP request only if the following criteria are satisfied: (a) a target IP address in the ARP request is a local IP address configured on the incoming interface, and (b) the sender's IP address is also part of the same IP subnet as the incoming interface. In the case of the external ARP request received at the physical network interface 122 of the host device 102, the incoming interface is the physical network interface 122. In an example where the remote client 108 is assigned an IP address 10.16.33.x (where x can be any value), and the physical network interface 122 is assigned an IP address 10.16.33.85/24, then the remote client 108 and the physical network interface 122 would be on the same IP subnet (identified by the routing prefix 10.16.33). In this example, the physical network interface 122 would reply to the external ARP request since criteria (a) and (b) are satisfied. In this case, the reply from the physical network interface 122 is an ignore indication, e.g., the physical network interface 122 may ignore the external ARP request and not send a message. Note that if the physical network interface 122 and the remote client 108 are not part of the same IP subnet, then criterion (b) is not satisfied and the physical network interface 122 would simply drop the external ARP request. In any of the foregoing examples, the host device 102 does not respond to the external ARP request so that the remote client 108 would not receive multiple ARP responses with potentially conflicting information. Effectively, the host device 102 ignores the external ARP request.

If the OS kernel 124 is a Linux OS kernel, then in some examples the ARP-related configuration setting 131 includes proc entries of the Linux OS kernel as follows:
1: echo 1>/proc/sys/net/ipv4/conf/virtual_gw_bridge/src_valid_mark
2: echo 2>/proc/sys/net/ipv4/conf/all/arp_ignore
3: echo 2>/proc/sys/net/ipv4/conf/virtual_gw_bridge/rp_filter.

Proc entry 1 referring to “src_valid_mark” specifies that for both the forward and reverse directions (outbound and inbound directions), a route lookup of a traffic flow will use the value of the alternate route indicator FWMARK to select which routing table to use. With the Linux OS kernel, the default value for src_valid_mark is set to 0, which means that the FWMARK is used only for the forward direction traffic and not for the reverse direction. In some examples, the value of src_valid_mark is set to 1 to use FWMARK for both the forward and reverse directions.

Proc entry 2 above specifies that incoming ARP requests from an external entity are to be ignored.

Proc entry 3 sets the value of rp_filter to 2 (instead of 1) since the route and interface information for the virtual gateway bridge 116 has been moved to the alternate routing table 136. The value of rp_filter controls how validation of a source IP address is performed on a received packet by the Linux OS kernel. By setting the value of rp_filter to 2, if the source address of the received packet at an interface is routable with any of the routes on any interface, then the packet is accepted by the Linux OS kernel.

For other types of OS kernels, different ARP-related configuration settings can be employed to specify criteria (a) and (b).

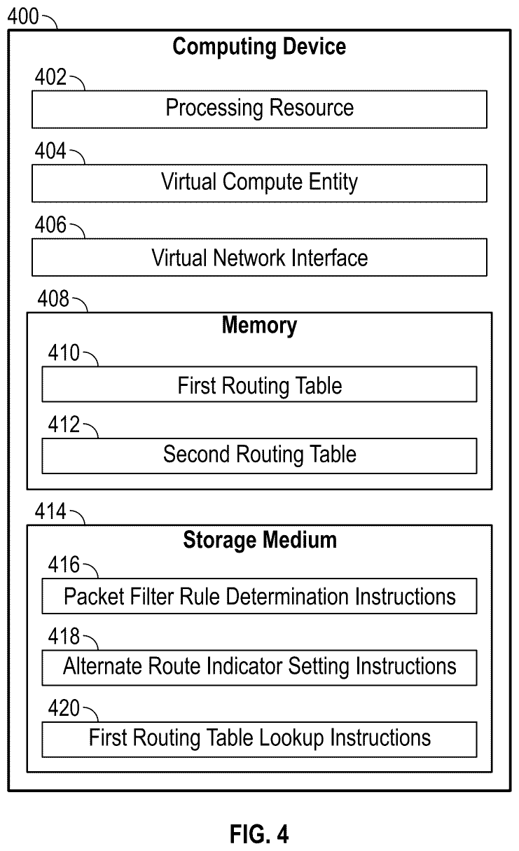

FIG. 4 is a block diagram of a block diagram of a computing device 400 according to some examples of the present disclosure. An example of the computing device 400 is the host device 102 of FIG. 1.

The computing device 400 includes a processing resource 402, which can include one or more hardware processors. A hardware processor can include a microprocessor, a core of a multi-core microprocessor, a microcontroller, a programmable integrated circuit, a programmable gate array, or another hardware processing circuit.

The computing device 400 further includes a virtual compute entity 404, which can be a container or a VM. The computing device 400 also includes a virtual network interface 406 between the virtual compute entity 404 and a network (e.g., 104 in FIG. 1) outside the computing device 400. An example of the virtual network interface 406 is the virtual gateway bridge 116 of FIG. 1. The virtual network interface 406 is an entity through which data is transferred between an internal entity of the computing device 400 and an external entity. The virtual network interface 406 part of a first IP subnet, such as the virtual interface IP subnet discussed further above.

The computing device 400 includes a memory 408 that stores a first routing table 410 used for routing of packets directed to the virtual network interface 406, and a second routing table 412 used for routing of packets directed to another interface different from the virtual network interface 406 in the computing device 400. An example of the first routing table 410 is the alternate routing table 136 of FIG. 1. An example of the second routing table 412 is a main or local routing table 134.

The computing device 400 further includes a storage medium 414 storing machine-readable instructions executable on the processing resource 402 to perform various tasks. In some examples, the machine-readable instructions are part of an OS kernel in the computing device 400. In other examples, the machine-readable instructions can be part of other programs in the computing device 400.

The machine-readable instructions include packet filter rule determination instructions 416 to determine whether a packet satisfies a packet filter rule. For example, the packet can be an IP packet, and the packet filter rule is part of the L3 packet filter rules 144 of FIG. 1.

The machine-readable instructions include alternate route indicator setting instructions 418 to, based on the packet satisfying the packet filter rule, associate the packet with an alternate route indicator for an IP flow. The alternate route indicator specifies use of the first routing table 410 instead of the second routing table 412 to address an IP subnet collision between the first IP subnet of the virtual network interface 406 and an IP subnet of another entity (external entity outside the computing device 400 or internal entity in the computing device 400).

The machine-readable instructions include first routing table lookup instructions 420 to, responsive to the alternate route indicator, perform a lookup of the first routing table to determine a route for the packet. The first routing table can be used to route the packet to the external entity or the internal entity.

In some examples, the machine-readable instructions can include the alternate route indicator as packet metadata (e.g., 142 in FIG. 1) associated with the IP flow that includes packets satisfying the packet filter rule. The packet metadata can be stored in the memory 408.

In some examples, the machine-readable instructions can include the alternate route indicator in a connection tracking entry (e.g., 150 in FIG. 1) used by a firewall of the computing device.

In some examples, the machine-readable instructions can create the first routing table for the virtual network interface 406.

In some examples, the packet is an inbound packet from an external entity outside the computing device 400 to the virtual compute entity 404 inside the computing device, or an outbound packet from the virtual compute entity 404 to the external entity, or an internal packet sent from an internal entity (e.g., the host application 128 of FIG. 1) in the computing device 400 to the virtual compute entity 404.

In some examples, the processing of the layer 2 packet includes validating the layer 2 packet using the first routing table 410. In some examples, the validation includes checking that an IP address contained in the layer 2 packet identifies an entity inside the computing device 400.

In some examples, the layer 2 packet is an ARP packet, and the validation includes checking that an IP address contained in the ARP packet identifies the entity inside the computing device.

In some examples, the entity inside the computing device 400 identified by the IP address contained in the ARP packet is the virtual compute entity 404.

In some examples, the machine-readable instructions can perform a lookup of an ARP table to obtain a MAC packet corresponding to the IP address contained in the ARP packet.

In some examples, the machine-readable instructions can program a configuration setting of an OS kernel specifying that an interface replies to an ARP request only if a target IP address in the ARP request is a local IP address configured on the interface, and an IP address of a sender of the ARP request is also part of a same IP subnet as the interface.

In some examples, based on the configuration setting, the machine-readable instructions can ignore an ARP request from an external entity outside the computing device 400.

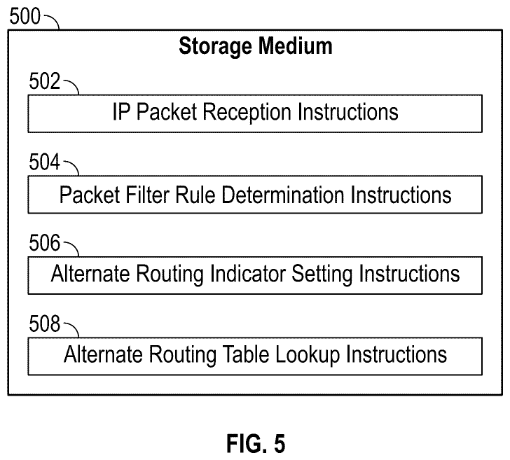

FIG. 5 is a block diagram of a non-transitory machine-readable or computer-readable storage medium 500 storing machine-readable instructions that upon execution cause a computing device (e.g., the host device 102 of FIG. 1) to perform various tasks.

The machine-readable instructions in the storage medium 500 include IP packet reception instructions 502 to receive an IP packet sent from a source entity. The source entity can be inside the computing device or outside the computing device.

The machine-readable instructions in the storage medium 500 include packet filter rule determination instructions 504 to determine whether the IP packet satisfies a packet filter rule relating to resolving an IP subnet collision between a virtual network interface of the computing device and another entity that is outside of or inside the computing device. The packet filter rule can be part of the L3 packet filter rules 144 of FIG. 1.

The machine-readable instructions in the storage medium 500 include alternate route indicator setting instructions 506 to, based on the IP packet satisfying the packet filter rule, associate the IP packet with an alternate route indicator for an IP flow, the alternate route indicator specifying use of an alternate routing table instead of a primary routing table.

The machine-readable instructions in the storage medium 500 include alternate routing table lookup instructions 508 to, responsive to the alternate route indicator, perform a lookup of the alternate routing table to determine a route for the IP packet.

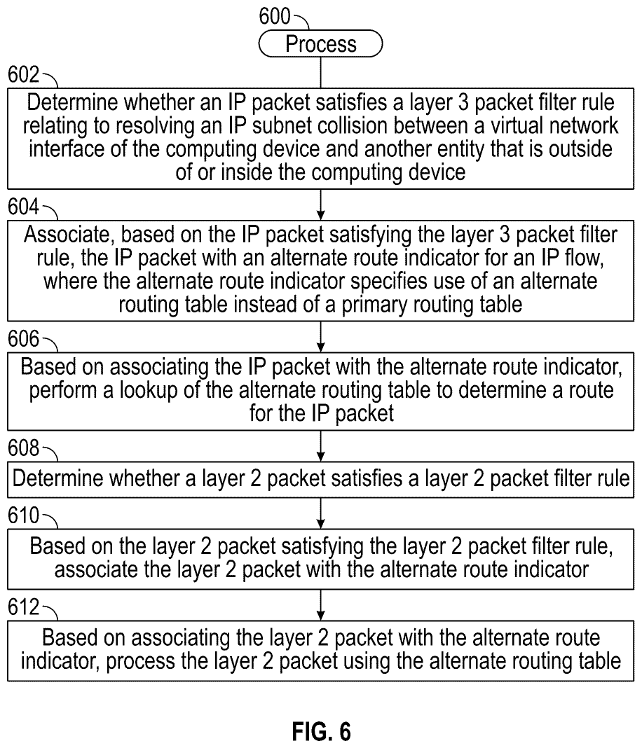

FIG. 6 is a flow diagram of a process 600 according to some examples, which may be performed in a computing device (e.g., the host device 102 of FIG. 1).

The process 600 includes determining (at 602), by the computing device, whether an IP packet satisfies a layer 3 packet filter rule relating to resolving an IP subnet collision between a virtual network interface of the computing device and another entity that is outside of or inside the computing device.

The process 600 includes associating (at 604), by the computing device based on the IP packet satisfying the layer 3 packet filter rule, the IP packet with an alternate route indicator for an IP flow. The alternate route indicator specifies use of an alternate routing table instead of a primary routing table.

Based on associating the IP packet with the alternate route indicator, the process 600 includes performing (at 606), by the computing device, a lookup of the alternate routing table to determine a route for the IP packet.

The process 600 includes determining (at 608), by the computing device, whether a layer 2 packet satisfies a layer 2 packet filter rule. The layer 2 packet may be an ARP packet.

Based on the layer 2 packet satisfying the layer 2 packet filter rule, the process 600 includes associating (at 610), by the computing device, the layer 2 packet with the alternate route indicator.

Based on associating the layer 2 packet with the alternate route indicator, the process 600 includes processing (at 612), by the computing device, the layer 2 packet using the alternate routing table.

A memory can be implemented with one or more memory devices. A persistent memory can be implemented with one or more flash memory devices or other types of memory devices that are able to maintain stored data even if power were removed. A volatile memory can be implemented with one or more dynamic random access memory (DRAM) devices, static random access memory (SRAM) devices, or other types of memory devices that lose stored data if power were removed.

A storage medium (e.g., 414 in FIG. 4 or 500 in FIG. 5) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
a processing resource;
a virtual compute entity;
a virtual network interface between the virtual compute entity and a network outside the computing device, the virtual network interface being part of a first Internet Protocol (IP) subnet;
a memory to store:
a first routing table used for routing of packets directed to the virtual network interface, and
a second routing table used for routing of packets directed to another interface different from the virtual network interface in the computing device; and
a non-transitory storage medium storing instructions executable on the processing resource to:
determine whether a packet satisfies a packet filter rule,
based on the packet satisfying the packet filter rule, associate the packet with an alternate route indicator for an IP flow, the alternate route indicator specifying use of the first routing table instead of the second routing table to address an IP subnet collision between the first IP subnet of the virtual network interface and an IP subnet of another entity, and
responsive to the alternate route indicator, perform a lookup of the first routing table to determine a route for the packet.

2. The computing device of claim 1, wherein the instructions are executable on the processing resource to:
include the alternate route indicator as metadata associated with the IP flow that includes packets satisfying the packet filter rule, the metadata stored in the memory.

3. The computing device of claim 1, wherein the instructions are executable on the processing resource to:
include the alternate route indicator in a connection tracking entry used by a firewall of the computing device.

4. The computing device of claim 1, wherein the packet filter rule comprises a layer 3 packet filter rule, and wherein the packet comprises an IP packet.

5. The computing device of claim 1, wherein the determining of whether the packet satisfies the packet filter rule comprises determining whether information in the packet satisfies the packet filter rule.

6. The computing device of claim 1, wherein the instructions are executable on the processing resource to:
create the first routing table for the virtual network interface.

7. The computing device of claim 1, wherein the packet comprises:
an inbound packet from an external entity outside the computing device to the virtual compute entity inside the computing device, or
an outbound packet from the virtual compute entity to the external entity, or
an internal packet sent from an internal entity in the computing device to the virtual compute entity.

8. The computing device of claim 1, wherein the instructions are executable on the processing resource to:
receive a layer 2 packet;
determine whether the layer 2 packet satisfies a layer 2 packet filter rule,
based on the layer 2 packet satisfying the layer 2 packet filter rule, associate the layer 2 packet with the alternate route indicator, and
responsive to the association of the layer 2 packet with the alternate route indicator, use the first routing table to process the layer 2 packet.

9. The computing device of claim 8, wherein the processing of the layer 2 packet comprises validating the layer 2 packet using the first routing table.

10. The computing device of claim 9, wherein the validating comprises checking that an IP address contained in the layer 2 packet identifies an entity inside the computing device.

11. The computing device of claim 10, wherein the layer 2 packet comprises an Address Resolution Protocol (ARP) packet, and wherein the validating comprises checking that an IP address contained in the ARP packet identifies the entity inside the computing device.

12. The computing device of claim 11, wherein the entity inside the computing device identified by the IP address contained in the ARP packet is the virtual compute entity.

13. The computing device of claim 12, wherein the instructions are executable on the processing resource to:
perform a lookup of an ARP table to obtain a Media Access Control (MAC) packet corresponding to the IP address contained in the ARP packet.

14. The computing device of claim 1, wherein the instructions are executable on the processing resource to:
program a configuration setting of an operating system (OS) kernel specifying that an interface replies to an Address Resolution Protocol (ARP) request only if a target IP address in the ARP request is a local IP address configured on the interface, and an IP address of a sender of the ARP request is also part of a same IP subnet as the interface.

15. The computing device of claim 14, wherein the instructions are executable on the processing resource to:
based on the configuration setting, ignore an ARP request from an external entity outside the computing device.

16. A non-transitory machine-readable storage medium comprising instructions that upon execution cause a computing device to:
receive an Internet Protocol (IP) packet sent from a source entity;
determine whether the IP packet satisfies a packet filter rule relating to resolving an IP subnet collision between a virtual network interface of the computing device and another entity that is outside of or inside the computing device;
based on the IP packet satisfying the packet filter rule, associate the IP packet with an alternate route indicator for an IP flow, the alternate route indicator specifying use of an alternate routing table instead of a primary routing table, and
responsive to the alternate route indicator, perform a lookup of the alternate routing table to determine a route for the IP packet.

17. The non-transitory machine-readable storage medium of claim 16, wherein the instructions upon execution cause the computing device to:
receive an Address Resolution Protocol (ARP) packet from an internal entity in the computing device;
determine whether the ARP packet satisfies a layer 2 packet filter rule specifying that ARP packets targeted to the virtual network interface are to be associated with alternate route indicator;
based on the ARP packet satisfying the layer 2 packet filter rule, associate the ARP packet with the alternate route indicator; and
responsive to associating the alternate route indicator with the ARP packet, validate the ARP packet by accessing the alternate routing table.

18. The non-transitory machine-readable storage medium of claim 16, wherein the instructions upon execution cause the computing device to:
program a configuration setting of an operating system (OS) kernel specifying that an interface replies to an Address Resolution Protocol (ARP) request only if a target IP address in the ARP request is a local IP address configured on the interface, and an IP address of a sender of the ARP request is also part of a same IP subnet as the interface; and
based on the configuration setting, ignore an ARP request from an external entity outside the computing device.

19. A method comprising:
determining, by a computing device, whether an Internet Protocol (IP) packet satisfies a layer 3 packet filter rule relating to resolving an IP subnet collision between a virtual network interface of the computing device and another entity that is outside of or inside the computing device;
based on the IP packet satisfying the layer 3 packet filter rule, associating, by the computing device, the IP packet with an alternate route indicator for an IP flow, the alternate route indicator specifying use of an alternate routing table instead of a primary routing table;
based on associating the IP packet with the alternate route indicator, performing, by the computing device, a lookup of the alternate routing table to determine a route for the IP packet;
determining, by the computing device, whether a layer 2 packet satisfies a layer 2 packet filter rule,
based on the layer 2 packet satisfying the layer 2 packet filter rule, associating, by the computing device, the layer 2 packet with the alternate route indicator, and
based on associating the layer 2 packet with the alternate route indicator, processing, by the computing device, the layer 2 packet using the alternate routing table.

20. The method of claim 19, further comprising:
programming, at the computing device, a configuration setting of an operating system (OS) kernel specifying that an interface replies to an Address Resolution Protocol (ARP) request only if a target IP address in the ARP request is a local IP address configured on the interface, and an IP address of a sender of the ARP request is also part of a same IP subnet as the interface; and
based on the configuration setting, ignoring, by the computing device, an ARP request from an external entity outside the computing device.
